(19) United States
(12) Patent Application Publication
(10) Pub. No.: US 2016/0220079 A1
(43) Pub. Date: Aug. 4, 2016

(54) INTERACTIVE POTTY CHAIR

(71) Applicants: Eyall ABIR, Petach Tikva (IL); Alex GERSHTEIN, Ashdod (IL)

(72) Inventors: Eyall Abir, Petach Tikva (IL); Alex Gershtein, Petach Tikva (IL)

(21) Appl. No.: 14/917,900

(22) PCT Filed: Sep. 10, 2014
(86) PCT No.: PCT/IL14/50802

§ 371 Date: Mar. 9, 2016

Related U.S. Application Data
(60) Provisional application No. 61/875,758, filed on Sep. 10, 2013.

(51) Int. Cl. A47K 11/04; G08B 21/18; A47K 13/24

(52) U.S. Cl. CPC A47K 11/04; A47K 13/24; G08B 21/18

(57) ABSTRACT

A system for sensing and monitoring excretion produced in a toilet bowl by a user. The system comprises at least a toilet seat for positioning on the toilet bowl, where the toilet seat comprises at least one sensor for sensing the excretion. Communication means provides an indication that the excretion produced by the user is in the toilet bowl. The system further comprises a remote receiver for receiving the indication and providing feedback thereof.

### FIELD OF THE INVENTION

The invention relates to the field of potty chairs.

### BACKGROUND OF THE INVENTION

Children's potty chairs having a mechanism for sounding musical tones upon use by the child are known. Many such devices utilize a commercially available music box mechanism for producing the desired musical tones. Some devices are battery operated, see for example, U.S. Pat. No. 3,691,980, issued Sep. 19, 1972 to Shastal, while others are spring actuated, such as the music box of U.S. Pat. No. 4,777,680, issued Oct. 18, 1988 to Paz.

Additional prior art devices include: U.S. Pat. No. 4,162,490, U.S. Pat. No. 6,698,036, U.S. Pat. No. 6,772,454, U.S. Pat. No. 7,194,776, U.S. 2013/0110064 and WO 2011/092584.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

Accordingly, it is a principal object of the present invention to provide an interactive potty chair, which overcomes the deficiencies and drawbacks associated with the prior art.

The present invention provides a system for sensing and monitoring excretion produced in a toilet bowl by a user. The system comprises at least a toilet seat for positioning on the toilet bowl, where the toilet seat comprises at least one sensor for sensing the excretion, and communication means for providing indication that the excretion produced by the user is in the toilet bowl. The system further comprises a remote receiver for receiving the indication and providing feedback thereof.

According to the preferred embodiment, the human excretion is urine or excrement.

Preferably, the at least one sensor is attached to or integrally joined with the toilet seat.

The at least one sensor is optionally a photodetector and may be chosen from the group comprised of: a CCD, CMOS, LDR, photovoltaic cell, photodiodes, phototransistor, IR, inductive, capacitance, galvanic, Hall Effect detector, acoustic detector, magnetic detector and color detector.

The sensor preferably comprises a microcontroller configured to process the output signal received from sensor and to perform computations determining the type of indication.

The indication is preferably selected from one or more of the following: audio, visual, vibration.

Optionally, the sensor detects when the user sits down on the toilet seat and when the user gets off the toilet seat. Alternatively, the sensor detects when the user sits down on the toilet seat, and a second sensor detects when the user gets off the toilet seat.

Preferably, the sensor communicates to the user via any one of an audio, visual and vibration alert.

Preferably, the sensor communicates with the remote receiver via acoustic communication or radio frequency.

The remote receiver is preferably a portable handheld device and optionally a smartphone.

The remote receiver optionally comprises one or more games, and transmits feedback to the user via the toilet seat.

The remote receiver is optionally capable of communicating with a smartphone.

The system optionally further comprises a toilet bowl to which the toilet seat is mounted thereon and attached thereto.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows an illustration of acoustical transmitter, destination, transmitted and receiving waves;

FIG. 2 shows an illustration of an electronic block diagram;

FIG. 3 shows an illustration of a software algorithm flowchart;

FIG. 4 shows an illustration of the acoustical dowel;

FIG. 5 shows an illustration of a musical potty seat and a smartphone;

FIG. 6 shows a schematic illustration of an exemplary acoustic communication interface between a potty chair and a receiving device; and,

FIG. 7 shows the PWM waveform of the present invention.

### DETAILED DESCRIPTION OF THE PREFERRED EMBODIMENTS

Disclosed herein is a system for sensing and monitoring urine and stool excretion in a potty chair, or toilet bowl (hereinafter “potty”).

One or multiple sensors are attached to, embedded in or integrally formed with such a potty in order to sense urine and/or stool excretion of the human (for example a child) sitting on the potty.

Although the invention described herein is with reference to potty training of a young child, it is understood that the application of the invention is not limited to usage by a young child or for potty training purposes. An adult user may utilize the present invention as well, for instance, for medical applications, such as monitoring amount and frequency of excrement.

The sensor outputs an indicative alert, such as an audio, visual and/or tactile alert, when urine and/or stool excretion are detected. In an embodiment, a photodetector (also “light sensor”) such as a CCD, CMOS, LDR (Light Dependent Resistor), photovoltaic cell, photodiodes (operative in photovoltaic mode or photoconductive mode), phototransistor, IR, inductive, capacitance, galvanic, Hall Effect detector, acoustic detector, magnetic detector, color detector, and/or the like may be used for detecting urine and/or stool excretion. For example, one or more of the sensors disclosed in U.S. Provisional Patent Application 61/860,277 to Abir and/or in PCT Publication No. WO2012/160546 to Abir may be used. These two documents are incorporated herein by reference in their entirety.

In some embodiments, the sensor comprises a microcontroller configured to process the output signal received from sensor and to perform computations determining the alerting.

The same or a different sensor may be used to detect when the child sits on the potty and/or when the child raises from the potty.

Responsive to this detection, music may be played and/or stopped, respectively. Alternatively or additionally, an indication may be shown on a receiving device, described herein below, responsive to the detection.

The communication can be bidirectional, from the potty to the receiving device, and/or from the receiving device to the potty. In such communication many configuration features can be adjust regard feedback and enhance the potty-training process. As for a example the child can play potty training oriented game on the receiving device, and the receiving sends feedback to the potty chair mechanism such as vibration, sounds, etc.

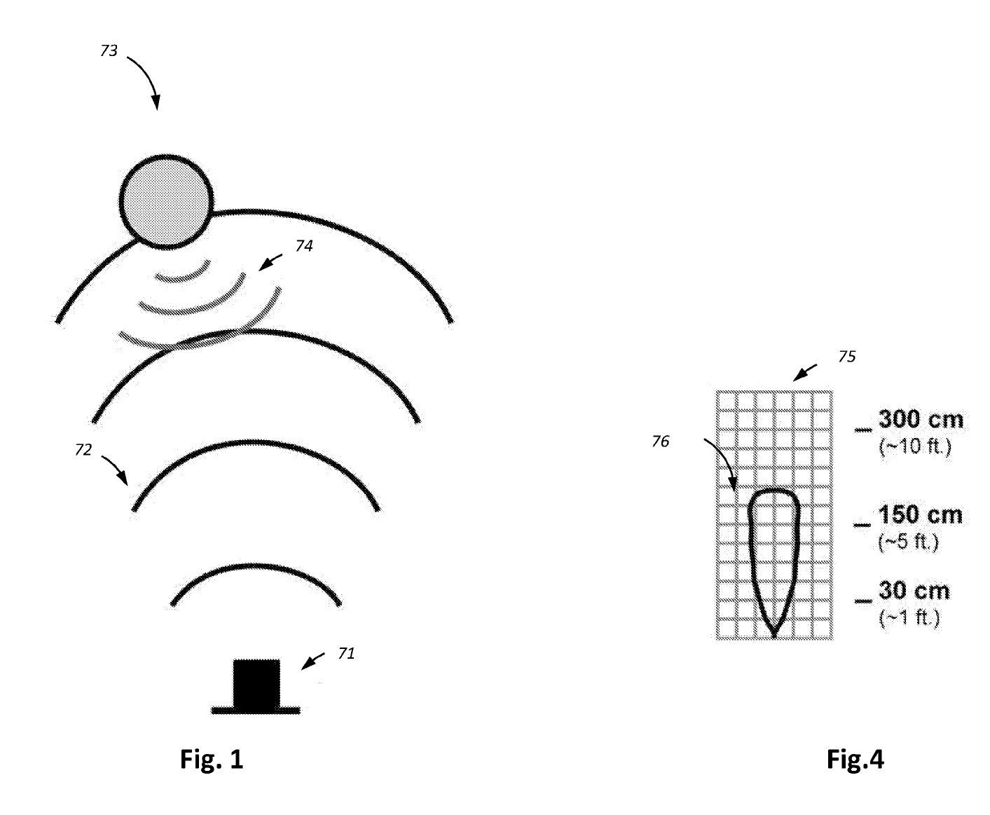

The present disclosure may be better understood with reference to the accompanying figures. Reference is now made to FIG. 1, which shows an ultrasonic sensor 71 sending sound waves 72 toward the toilet seat water 73, also known as the “destination”. The sound waves hit the water and naturally propagate 74 back to sensor 71.

The user who sits on the toilet may moving during use. The movement can cause an unwanted change in measuring “distance” from water. Therefore an electronic compass or a gyro is used to sense the changes in direction along the X, Y and Z axes.

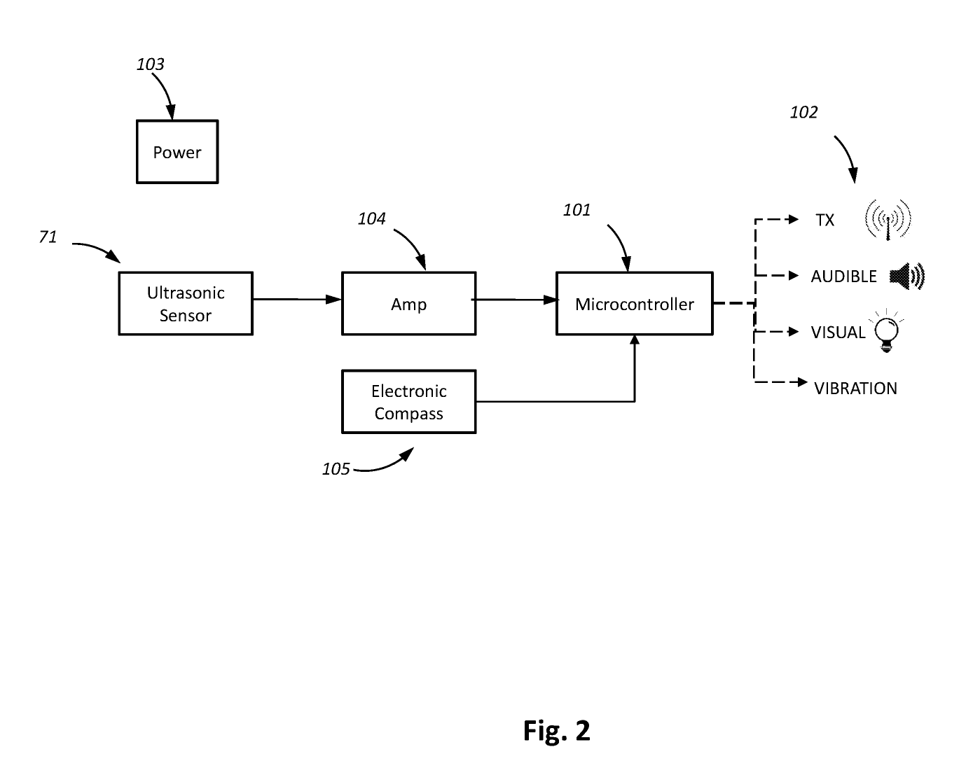

Reference is now made to FIG. 2, which shows an electronic circuit, in an exemplary block diagram, of the potty seat sensor. Power 103 is turned on. Ultrasonic sensor 71 sends and receives sound waves from the toilet seat water (not shown). In a preferred embodiment, sensor 71 comprises an ultrasonic transmitter and receiver. The receiving sound waves are amplified 104, then fed to a microcontroller 101 and proceed inside the microcontroller 101 into PWM pulses. Additionally, the electronic compass or gyro 105 output feeds the microcontroller with the X, Y and Z axes heading variables.

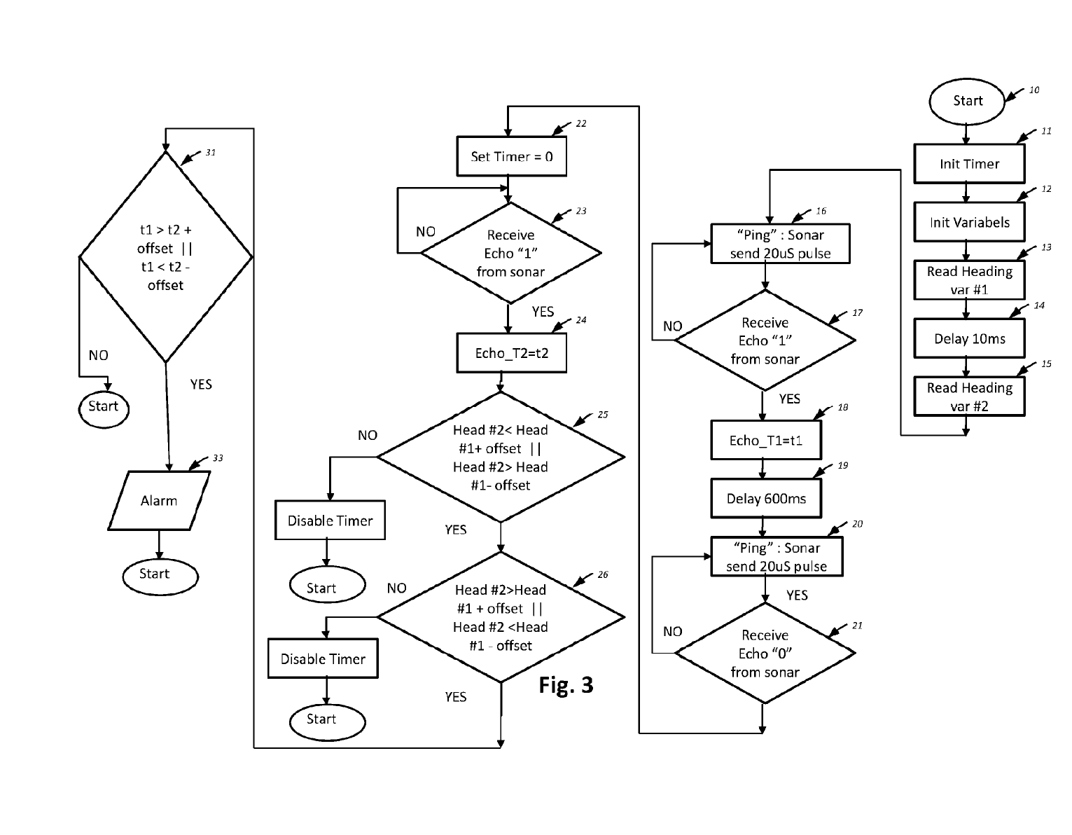

Reference is now made to FIG. 3, which shows a flow chart, in an exemplary algorithm, for detecting excretion in the toilet bowl, after power on the algorithm starts running 10, variables are zeroed 11, timer is initialized 12 and the microcontroller is initialized. The electronic compass is enabled by measuring the two Heading variables from it. Each X, Y and Z axis contains these two Heading variables. The microcontroller initiates the first reading and store the results in the Head1 variable 13, then after 10 milliseconds 14, a second reading is taken and the result is stored in the Head2 variable 15. Ultrasonic sensor 71 is ordered to send a 20 microseconds pulse 16. If a returning echo signal corresponds to logic High (‘1’) 17, then Time stamp t1 is stored 18. After 600 milliseconds 19, another 20 microseconds pulse is sent 20. If a returning echo signal corresponds to logic Low (‘0’) 21, then timer is disabled 22. If a returning echo signal corresponds to logic High (‘1’) 23 then Time stamp t2 is stored 24.

In order to check whether the platform which sensor 71 is placed on, then the Heading variables are checked for differences in two IF' s statements 25 and 26. The offset may be determined automatically when powering-up sensor 71 by this way the sensor is dynamically can adapt to any kind of toilet seat, or hardcoded.

If there is a differences in the second IF statement 26, that means there is no movement. Then the t1 and t2 timing differences are checked in IF statement 31. The offset may be determined automatically when power-up the sensor or hardcoded.

Then if statement result is positive then sensor activates the alarm 33. Alarm 33 can be an audio, visual, RF such as BLE.

Sensor 71 is very sensitive for short range distances. Reference is now made to FIG. 4 which shows a distance grid 75 and a dowel 76. From this figure we can see that a 30 cm diameter and a distance of 150 cm is effective for typical toilet seat dimensions.

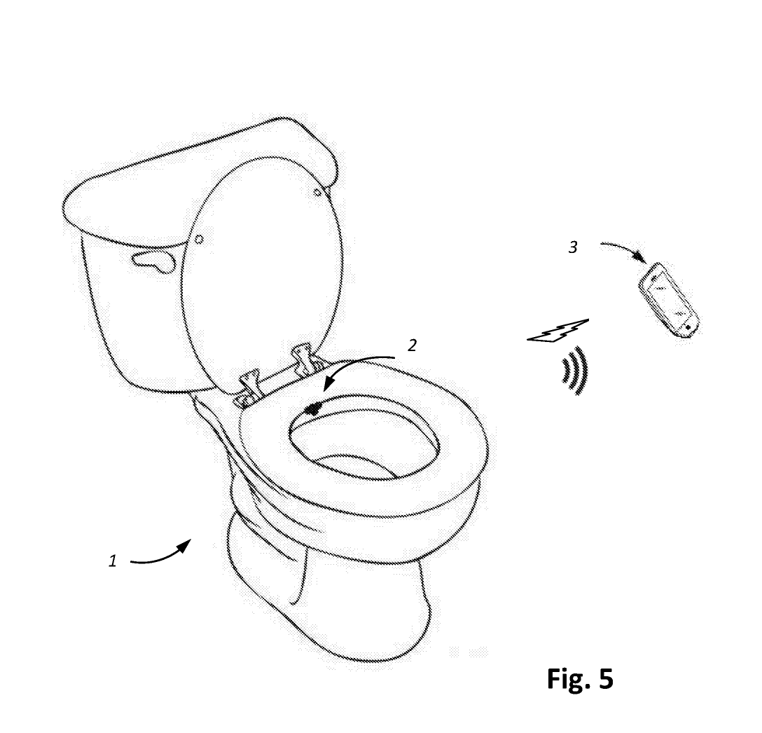

Referring to FIG. 5, illustrating the system of the invention, showing a potty chair 1 equipped with the toilet seat 2 of the present invention having a combined audible urine and/or stool sensor and a receiving device 3 nearby. Receiving device 3 is preferably any portable and/or handheld computing device, such as a smartphone or other dedicated device.

When the sensor detects the excretion, the communication means outputs feedback to the user in the form of one or more of a vibration alert, a visual alert, a vocal alert, and then transmit the alert indication to the receiving device.

According to the preferred embodiment, the potty chair disclosed herein interfaces and/or communicates with an external and/or remote device to convey a feedback signal (or, alert) generated by the at least one sensor disclosed herein to the device (herein also, a “receiver” or a “receiving device”). Conveying the signal from the sensor of the potty chair to the receiving device may be performed by various communication routes, such as radio frequency and/or acoustic communication. Acoustic communication makes use of sound and/or ultrasound, whereby a “transmitter” produces a sound that is detected by a “receiver”. Sound is produced by the transmitter when a physical object vibrates rapidly, disturbs nearby air molecules (or other surrounding medium) and generates compression waves that travel in all directions away from the source. Sound can be made to vary in frequency (high pitch vs. low pitch), amplitude (loudness), and periodicity (the temporal pattern of frequency and amplitude). Since acoustic waves move rapidly through the medium, acoustic signals can be quickly started, stopped, or modified to send a time-sensitive message.

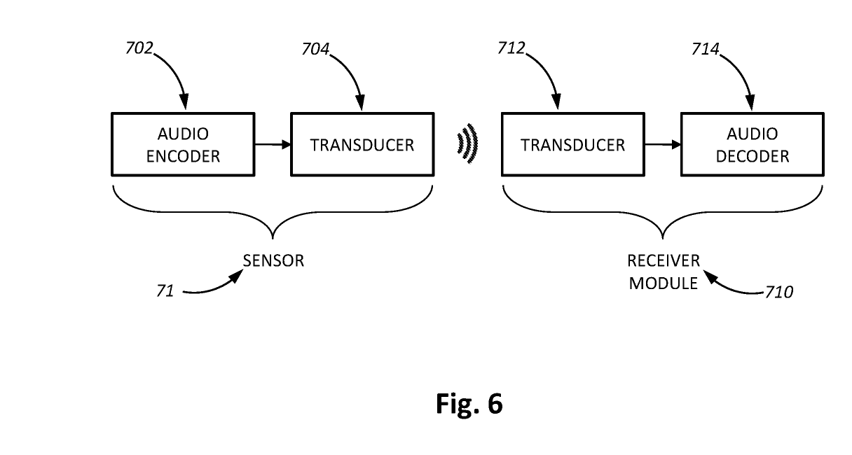

Reference is now made to FIG. 6, which shows a schematic illustration of an acoustic communication interface between a potty chair and a receiving device. Potty chair sensor 700 includes an audio encoder 702, adapted to produce an acoustic signal based on the signal produced by the sensor. Audio encoder 702 may be incorporated in the microcontroller as mentioned above, or be coupled with it. The Potty chair further includes a transducing element 704, adapted to convert an electrical signal from audio encoder 702 into an acoustic signal transmitted towards the remote receiver. In some embodiments, the transducing element 704 is a speaker. The acoustic signal produced by the potty chair sensor 71 may then be detected by transducer unit 712 of receiving device 710. In some exemplary embodiments, transducer 712 is a microphone. The acoustic signal may then be decoded by audio decoder 714 of the receiving device. Decoding the acoustic signal may be used to convert the acoustic signal to an electrical signal. The decoded signal may be processed and conveyed to a user. In some embodiments, the decoded signal may be converted to an alarm signal that may be a visual signal, a tactile signal, an audible signal, and the like, or any combination thereof.

In some embodiments, music played by the potty and/or a music device (such as the receiving device) operatively coupled to the potty also serves as a medium for transmitting the acoustic signal. Namely, audio decoder 714 at receiving device 710 may be configured to decode certain music played by the potty and attribute it to a urination and/or stool excretion event. In some embodiments, the acoustic signal may be separate from the music played, whether by superimposing the acoustic signal on the music, or by transmitting the acoustic signal at a different time than the music.

According to some embodiments, the receiving device may be portable. In some embodiments, the receiving device may be placed in the vicinity of the sensing device. In some embodiments, the receiving device may be placed at a remote location, but still in acoustic communication range from the transmitting device. In some exemplary embodiments, the receiving device is a smart phone. In some exemplary embodiments, the receiving device is configured to communicate with a smart phone. In some exemplary embodiments, the receiving device may be held by the child sitting on the potty, such that stimulation created by the device serves as feedback to the child using the potty. The stimulation may include, for example, one or more videos, images and/or sounds produced by or displayed by the receiving device.

In some other exemplary embodiments, the receiving device may be held by an adult overlooking the child, such that the adult is informed when the child secreted urine and/or stool in the potty.

In some embodiments, the receiving device is configured to communicate with an additional remote device via the Internet and/or via short-range radio, utilizing technologies such as WiFi, Bluetooth, SMS, cellular data communication, push notification protocol, and activate the alarm therein, in order to notify a supervisor which may be located in a remote location. The remote device may execute an application for communicating with the receiving device and to produce audible and/or visual alarm and/or tactile alarms.

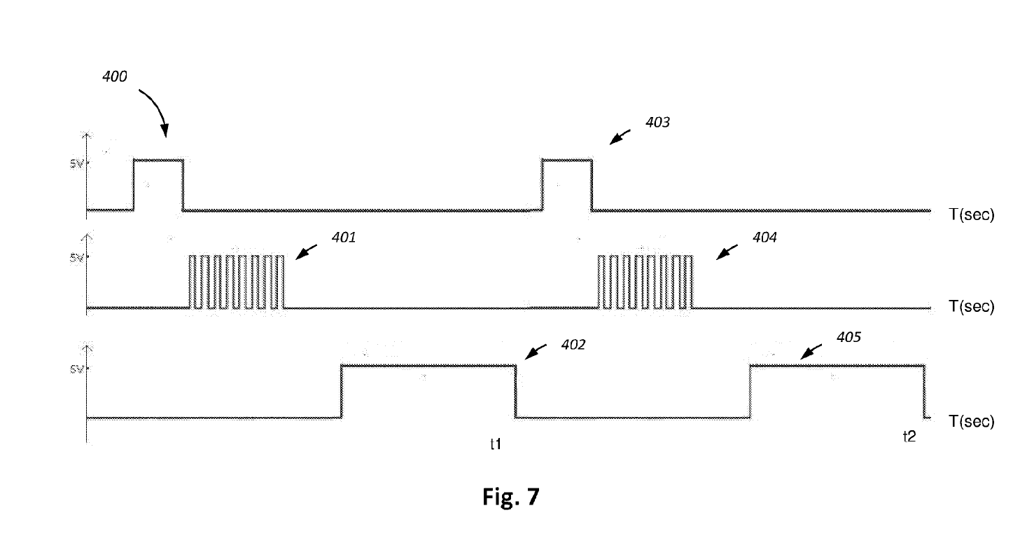

Reference is now made to FIG. 7, which shows the PWM waveform. As will be described below, a 20 microseconds pulse 400 triggers the ultrasonic sensor, then the sensor transmits a train of pulses (according to a preferred embodiment, in the frequency of 40 Khz, but can be another frequency in other embodiments) 401, then echo 402 from sensor is received, referred to as ‘t1’ time stamp.

A secondary 20 microseconds pulse 403 triggers the ultrasonic sensor, then the sensor transmits a train of pulses (according to a preferred embodiment, in the frequency of 40 Khz, can be another frequency in other embodiments) 404, then echo 405 from sensor is received referred to as ‘t2’ time stamp.

A returning sound wave 402 and 405 has a width proportional to the measured distance. In the present invention, the interference, as a result of soiled water, will change the Tof—‘time of flight’ of the sound waves.

Reference is now made back to FIG. 2, The PWM pulses are then fed into second software module which will determine whether there is excretion in the toilet bowl. Microcontroller 101 perform exemplary algorithm for detecting the excrement.

It is understood that the above description of the embodiments of the present invention are for illustrative purposes only, and is not meant to be exhaustive or to limit the invention to the precise form or forms disclosed, as many modifications and variations are possible. Such modifications and variations are intended to be included within the scope of the present invention as defined by the accompanying claims.

1. A system for sensing and monitoring excretion produced in a toilet bowl by a user, said system comprising at least a toilet seat for positioning on said toilet bowl, said toilet seat comprising at least one sensor for sensing said excretion, and communication means for providing indication of said excretion produced by said user is in said toilet bowl, and further comprising a remote receiver for receiving said indication and providing feedback thereof.

2. The system of claim 1, wherein the human excretion is urine

3. The system of claim 1, wherein the human excretion is excrement.

4. The system of claim 1, wherein the at least one sensor is attached to the toilet seat.

5. The system of claim 1, wherein the at least one sensor is integrally joined with the toilet seat.

6. The system of claim 1, wherein the at least one sensor is a photodetector and may be chosen from the group comprised of: a CCD, CMOS, LDR, photovoltaic cell, photodiodes, phototransistor, IR, inductive, capacitance, galvanic, Hall Effect detector, acoustic detector, magnetic detector and color detector.

7. The system of claim 1, wherein the sensor comprises a microcontroller configured to process the output signal received from sensor and to perform computations determining the type of indication.

8. The system of claim 7, wherein the indication is selected from one or more of the following: audio, visual, vibration.

9. The system of claim 1, wherein the sensor detects when the user sits down on the toilet seat and when the user gets off the toilet seat.

10. The system of claim 1, wherein the sensor detects when the user sits down on the toilet seat, and a second sensor detects when the user gets off the toilet seat.

11. The system of claim 1, wherein the sensor communicates to the user via any one of an audio, visual and vibration alert.

12. The system of claim 1, wherein the sensor communicates with the remote receiver via acoustic communication.

13. The system of claim 1, wherein the sensor communicates with the remote receiver via radio frequency.

14. The system of claim 1, wherein the remote receiver is a portable handheld device.

15. The system of claim 1, wherein the remote receiver is a smartphone.

16. The system of claim 1, wherein the remote receiver comprises one or more games, and transmits feedback to the user via the toilet seat.

17. The system of claim 1, wherein the remote receiver is capable of communicating with a smartphone.

18. The system of claim 1, further comprising a toilet bowl to which the toilet seat is mounted thereon and attached thereto.
